(19) United States
(12) Patent Application Publication
(10) Pub. No.: US 2025/0001799 A1
(43) Pub. Date: Jan. 2, 2025

(54) ROLLER AND WHEEL

(71) Applicant: Sony Interactive Entertainment Inc., Tokyo (JP)

(72) Inventor: Koichi OBANA, Tokyo (JP)

(73) Assignee: Sony Interactive Entertainment Inc., Tokyo (JP)

(21) Appl. No.: 18/706,014

(22) PCT Filed: Oct. 6, 2022
(86) PCT No.: PCT/JP2022/037433

§ 371 Date: Apr. 30, 2024

(30) Foreign Application Priority Data
Nov. 8, 2021 (JP) 2021-182089

(51) Int. Cl. B60B 19/00

(52) U.S. Cl. CPC B60B 19/00

(57) ABSTRACT

A roller includes a first member having a through hole into which a support shaft is inserted and a second member that covers an outer circumference surface of the first member. The first member and the second member are integrally formed by two-color molding. Although covering most part of the outer circumference surface including a central region of the first member, the second member does not cover outer circumference surfaces of both end portions.

### TECHNICAL FIELD

The present invention relates to a roller rotatably attached to an outer circumference of a wheel main body and a wheel including a plurality of the rollers.

### BACKGROUND ART

Mecanum wheels are known as wheels for realizing an omnidirectional movement mechanism that enables movement in front-and-back and left-and-right directions. The mecanum wheel includes a wheel main body and a plurality of barrel-shaped rollers rotatably attached to an outer circumference of the wheel main body.

FIG. 1(a) illustrates a structure of a conventional left mecanum wheel 20a, and FIG. 1(b) illustrates a structure of a conventional right mecanum wheel 20b. As illustrated in FIG. 1(a), in the left mecanum wheel 20a, a plurality of rollers 22 into which support shafts are inserted in a manner being inclined leftward and diagonally upward by 45 degrees relative to an axle are rotatably attached to the outer circumference of a wheel main body 21. Also, as illustrated in FIG. 1(b), in the right mecanum wheel 20b, the plurality of rollers 22 into which the support shafts are inserted in a manner being inclined rightward and diagonally upward by 45 degrees relative to the axle are rotatably attached to the outer circumference of the wheel main body 21. A movement mechanism including the two left mecanum wheels 20a and the two right mecanum wheels 20b enables rotational movement and omnidirectional movement.

### SUMMARY

### Technical Problem

The conventional roller 22 includes a pipe member 23 into which the support shaft is inserted and a rubber member 24 fitted onto an outer circumference surface of the pipe member 23. The conventional roller 22 is formed by having the rubber member 24 fitted onto the pipe member 23, which makes it necessary for the rubber member 24 to have sufficient strength not to break at the time of fitting. Accordingly, a certain thickness is required. Therefore, the structure of the conventional roller 22 is not suitable for downsizing, and this hinders the downsizing of the mecanum wheels 20.

It should be noted that not only the mecanum wheels but also omni wheels are known as wheels for realizing the omnidirectional movement mechanism that enables movement in the front-and-back and left-and-right directions. The omni wheel, as does the mecanum wheel, includes a wheel main body and a plurality of barrel-shaped rollers 22 rotatably attached to an outer circumference of the wheel main body. In the omni wheel, the plurality of rollers 22 into which the support shafts are inserted in a manner orthogonal to the axle are rotatably attached to the outer circumference of the wheel main body. The roller 22 of the conventional omni wheel also includes a pipe member 23 into which the support shaft is inserted and a rubber member 24 fitted onto an outer circumference surface of the pipe member 23, which hinders the downsizing of the omni wheel.

Therefore, it is an object of the present invention to provide a technology for downsizing the roller rotatably attached to the outer circumference of the wheel main body.

### Solution to Problem

In order to solve the above problem, an aspect of the present invention is a roller rotatably attached to an outer circumference of a wheel main body, the roller including a first member having a through hole into which a support shaft is inserted, and a second member adapted to cover an outer circumference surface of the first member. The first member and the second member are integrally formed by two-color molding.

Another aspect of the present invention is a wheel comprising a wheel main body and a plurality of rollers rotatably attached to an outer circumference of the wheel main body. The roller includes a first member having a through hole into which a support shaft is inserted and a second member that covers an outer circumference surface of the first member. The first member and the second member are integrally formed by two-color molding.

### BRIEF DESCRIPTION OF DRAWINGS

FIGS. 1(a) and 1(b) are views illustrating a structure of a conventional mecanum wheel.

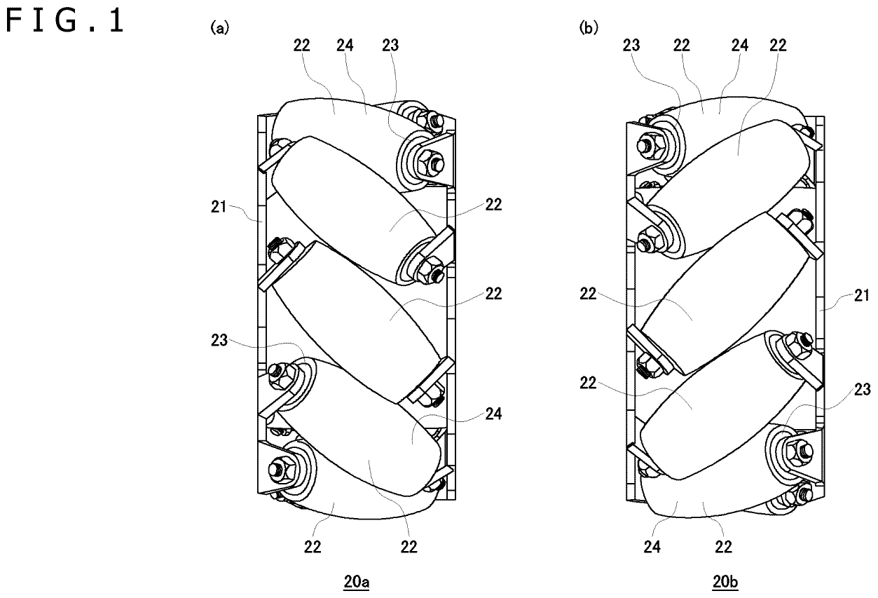

FIG. 2 is a view illustrating a structure of a wheel of a working example.

FIG. 3 is a view illustrating a cross section of a roller and an attachment structure thereof.

### Description of Embodiments

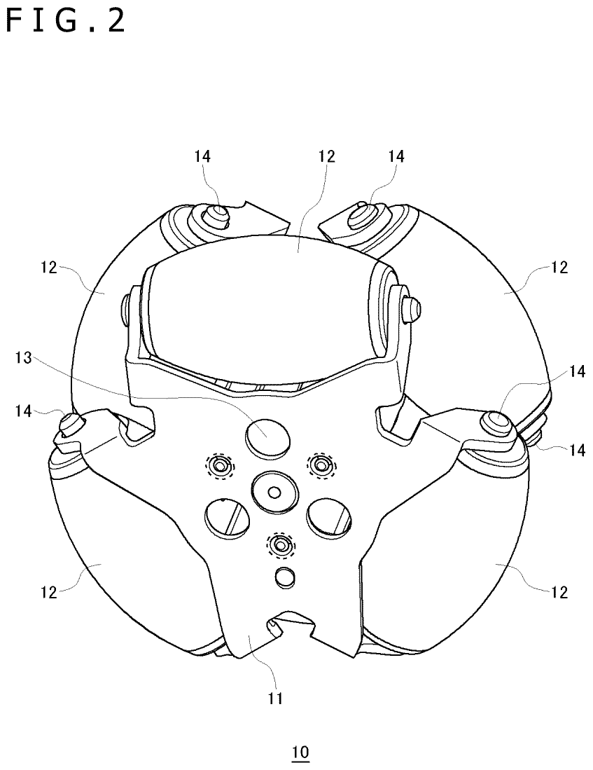

FIG. 2 illustrates a structure of a wheel 10 of a working example. The wheel 10 includes a wheel main body 11 including a metallic frame and a plurality of barrel-shaped rollers 12 rotatably attached to an outer circumference of the wheel main body 11. An axle securing section 13 for securing an axle extending from a mobile body (not illustrated) such as a vehicle is attached to a central portion of the wheel main body 11. The plurality of barrel-shaped rollers 12 have a through hole that passes through a central axis, and a support shaft 14 secured to the wheel main body 11 is inserted into the through hole.

The wheel 10 of the working example is an omni wheel that includes the plurality of rollers 12 into which the support shafts 14 orthogonal to the axle (not illustrated) are inserted. It should be noted that the wheel 10 may be a mecanum wheel that includes the plurality of rollers 12 into which the support shafts inclined diagonally (45 degrees) relative to the axle are inserted. Although the wheel 10 may be an omni wheel or a mecanum wheel, the wheel 10 may instead be a special wheel with the plurality of rollers 12 rotatably attached to the outer circumference of the wheel main body.

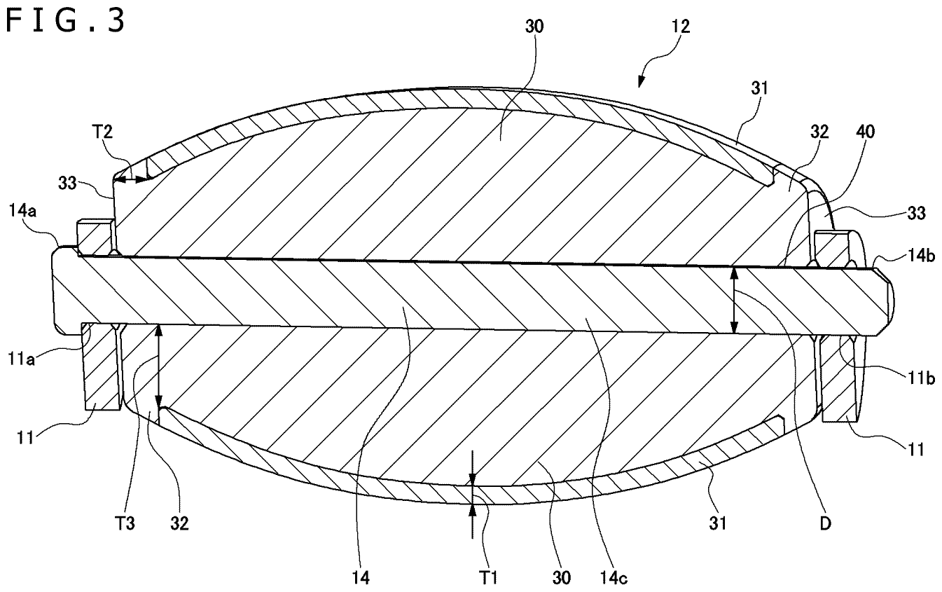

FIG. 3 illustrates a cross section of the roller 12 and an attachment structure thereof. The roller 12 includes a first member 30 having a through hole 40 into which the support shaft 14 is inserted and a second member 31 that covers an outer circumference surface of the first member 30. The first member 30 and the second member 31 are integrally formed by two-color molding.

It is preferred that the first member 30 be formed by a material such as polyacetal resin (POM) or polyetheretherketone resin (PEEK) to provide a high sliding property on the through hole 40. It should be noted that, if it is possible to provide the through hole 40 with the high sliding property by applying a glossy finish or the like, the first material 30 may be formed by a material such as polycarbonate resin (PC) or ABS resin.

The second member 31 is formed by a material such as thermoplastic polyurethane (TPU) or thermoplastic elastomer (TPE) and used as a tire component that touches the ground. The second member 31 may also be formed by a thermosetting elastomer such as silicone. Because the first member 30 and the second member 31 are formed by two-color molding as described above, it is preferred that the second member 31 be formed by a material that adheres tightly to the first member 30. As compared to the conventional roller 22 formed by fitting the rubber member 24 onto the pipe member 23, it is possible to downsize the roller 12 by integrally forming the first member 30 and the second member 31.

In the working example, the second member 31 is provided at an approximately uniform thickness T1 on the outer circumference surface of the first member 30. By forming the second member 31 at the approximately uniform thickness T1, it is possible to make an amount of sinking of the second member 31 touching the ground approximately constant, regardless of a rotation position of the wheel 10. For example, the thickness T1 of the second member 31 may be set to a constant value within a range from 0.2 mm to 1 mm.

The first member 30 includes two end portions 32 each of which has an end surface 33. Both end surfaces 33 of the first member 30 are not covered by the second member 31, and in consequence, the end surface 33 of the first member 30 is in contact with the wheel main body 11 that secures the support shaft 14. Thus, by providing the second member 31 at the position where it does not come in contact with the wheel main body 11, it is possible to avoid a situation where the second member 31 comes in contact with the wheel main body 11 and produces frictional resistance at the time of rotation of the roller 12 and a situation where the second member 31 wears out.

Although covering most part of the outer circumference surface including a central region of the first member 30, the second member 31 of the working example does not cover outer circumference surfaces of both end portions 32. The end portion 32 has a thickness T2 in an axial direction, and the second member 31 is not formed on the outer circumference surface of the end portion 32. For example, the second member 31 may, in cross-sectional view illustrated in FIG. 3, cover the region that accounts for 80% or more of the axial length of the first member 30. In the omni wheel, the second members 31 of the plurality of rollers 12 are arranged seamlessly in the circumferential direction and constitute the tire of the wheel 10. Accordingly, it is preferred that the thickness T2 of the end portion 32 where the second member 31 is not provided be as small as possible. For example, the thickness T2 of the end portion 32 in the axial direction may be set to a value within a range from 0.3 mm to 1 mm. It should be noted that a minimum thickness T3 of the first member 30 in a radial direction may be set to a value within a range from 0.4 mm to 2 mm.

The roller 12 formed by two-color molding is rotatably attached to a frame structure of the wheel main body 11 by the support shaft 14. The support shaft 14 has an axial portion 14c that is inserted into an opening 11a of the wheel main body 11, the through hole 40 of the first member 30, and an opening 11b of the wheel main body 11, and a flanged portion 14a that projects in the radial direction more than the axial portion 14c is provided on one end side thereof. A secured portion 14b that is the other end side of the support shaft 14 is secured to the wheel main body 11 with an adhesive. The secured portion 14b may be welded and secured to the wheel main body 11.

In order to downsize the roller 12, it is preferred that a diameter D of the axial portion 14c be reduced on a premise that its strength is assured. In the meantime, assuming that the diameter D of the axial portion 14c is smaller than 1 mm, it is not possible to secure the support shaft 14 with commercially available nuts because nuts whose diameter is smaller than 1 mm are not commercially available. In particular, therefore, in a case where the support shaft 14 having the diameter smaller than 1 mm is inserted into the through hole 40, it is preferred that the secured portion 14b of the support shaft 14 be secured to the wheel main body 11 with an adhesive or secured by welding. Thus, by reducing the diameter of the axial portion 14c of the support shaft 14 (e.g., diameter D<1 mm), it is possible to realize the downsizing of the wheel 10.

The present invention has been described above on the basis of the working example. It is to be understood by those skilled in the art that the above working example is illustrative, that various modification examples are possible regarding combinations of the respective components and processes thereof, and that such modification examples also fall within the scope of the present invention.

### INDUSTRIAL APPLICABILITY

The present invention is applicable to a roller rotatably attached to an outer circumference of a wheel main body and a wheel including a plurality of the rollers.

### REFERENCE SIGNS LIST

10: Wheel
11: Wheel main body
11a, 11b: Opening
12: Roller
13: Axle securing section
14: Support shaft
14a: Flanged portion
14b: Secured portion
14c: Axial portion
20a: Left mecanum wheel
20b: Right mecanum wheel
21: Wheel main body
22: Roller
30: First member
31: Second member
32: End portion
33: End surface
40: Through hole

1. A roller rotatably attached to an outer circumference of a wheel main body, the roller comprising:
a first member having a through hole into which a support shaft is inserted; and
a second member adapted to cover an outer circumference surface of the first member, wherein
the first member and the second member are integrally formed by two-color molding.

2. The roller according to claim 1, wherein the second member does not cover both end surfaces of the first member.

3. The roller according to claim 1, wherein the second member does not cover outer circumference surfaces of both end portions of the first member.

4. The roller according to claim 1, wherein
the second member is provided at an approximately uniform thickness on the outer circumference surface of the first member.

5. The roller according to claim 1, wherein
the support shaft having a diameter smaller than 1 mm is inserted into the through hole.

6. A wheel comprising a wheel main body and a plurality of rollers rotatably attached to an outer circumference of the wheel main body, wherein
the roller includes a first member having a through hole into which a support shaft is inserted and a second member that covers an outer circumference surface of the first member, and
the first member and the second member are integrally formed by two-color molding.

7. The wheel according to claim 6, wherein one end side of the support shaft is secured to the wheel main body with an adhesive or secured by welding.

8. The wheel according to claim 6, wherein the second member is provided at a position where it does not come in contact with the wheel main body to which the support shaft is attached.

9. The wheel according to claim 6 being an omni wheel or a mecanum wheel.
